(19) United States
(12) Patent Application Publication
(10) Pub. No.: US 2017/0168633 A1
(43) Pub. Date: Jun. 15, 2017

(54) TOUCH SENSITIVE ACTIVE PRIVACY SCREEN

(71) Applicant: INTEL CORPORATION, Santa Clara, CA (US)

(72) Inventors: Dong Yeung Kwak, San Jose, CA (US); Ramon C. Cancel Olmo, Hillsboro, OR (US); Thomas A. Nugraha, Tokyo (JP); Jue Li, Shanghai (CN); Seh W. Kwa, Saratoga, CA (US)

(73) Assignee: INTEL CORPORATION, Santa Clara, CA (US)

(21) Appl. No.: 15/038,795

(22) PCT Filed: Jun. 24, 2015
(86) PCT No.: PCT/CN2015/082189

§ 371 Date: May 24, 2016

(51) Int. Cl. G06F 3/041; G02F 1/1333; G06F 3/044

(52) U.S. Cl. CPC G06F 3/0416; G06F 3/044; G06F 3/0412; G02F 1/13338

(57) ABSTRACT

Disclosed herein are techniques related to privacy and touch at display devices. The techniques include an apparatus having a touch sensitive electroactive privacy layer of a display device. The touch sensitive electroactive privacy layer is configured to restrict a propagation direction of light emission associated with a display layer of the display device and to register or a touch event. The restriction of propagation is generated by micro louvers formed between privacy layer electrodes in the touch sensitive electroactive privacy layer while the registration of the touch event is detected by mutual capacitance between a touch electrode and one of the privacy layer electrodes.

### TECHNICAL FIELD

Embodiments herein generally relate to display devices and particularly to touch screens and active privacy screens for display devices.

### BACKGROUND

In computer systems, a display device may be used to display various image content. In some cases, a display device may include a touch screen, wherein tactile input can be received at the display device. Detachable privacy screens are sometimes used at display devices to restrict propagation direction of light emitted from the display device. In some cases, the use of privacy screens may inhibit or reduce functionality of a touch screen associated with the display device.

### BRIEF DESCRIPTION OF THE DRAWINGS

FIG. 1 illustrates a block diagram of a computing device and a display device including a touch sensitive electroactive privacy layer.

FIGS. 2A-2B illustrate block diagrams of a display device.

FIGS. 3A-3C illustrate block diagrams of examples of a touch sensitive electroactive privacy layer.

FIGS. 4-6 illustrate perspective views of the example touch sensitive electroactive privacy layers depicted in FIGS. 3A-3C.

FIGS. 7-8 illustrate equivalent circuit diagrams for portions of the touch sensitive electroactive privacy layers.

FIGS. 9-10 illustrate examples of a touch sensitive electroactive privacy layer during various modes.

FIG. 11 illustrates a graph of a voltage signal for changing the mode of the touch sensitive electroactive privacy layer.

FIGS. 12-14 illustrate block graphs of voltage pulses to scan for touch events.

FIG. 15 illustrates a logic flow according to an embodiment.

FIG. 16 illustrates a computer readable medium according to an embodiment.

FIG. 17 illustrates a device according to an embodiment.

### DETAILED DESCRIPTION

Various embodiments described herein are generally directed to a touch enabled active privacy apparatus for a display device. More specifically, a display device may include a touch sensitive electroactive privacy layer (TSEPL). The TSEPL layer provides both touch functionality and may restrict a direction of light propagating through the TSEPL when a “privacy mode” is selected but not restrict the direction of light propagating through the TSEPL when a “transparent mode” is selected. Furthermore, the activation of the privacy mode may not inhibit the touch sensitivity of the TSEPL.

In general, the TSEPL comprises a number of touch layer electrodes as well as privacy layer top and bottom electrodes. Additionally, a dielectric material may be disposed between the top and bottom electrodes. The touch layer electrodes may be configured to cooperate with the top layer privacy electrodes to register touch, for example, via mutual capacitance. Additionally, the top and bottom electrodes may be configured to activate portions of the dielectric material to form micro louvers. The micro louvers may restrict a propagation direction of light emitted from the display stack (e.g., from a display layer of the display stack, or the like).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, known structures and devices are shown in block diagram form in order to facilitate a description thereof. The intention is to provide a thorough description such that all modifications, equivalents, and alternatives within the scope of the claims are sufficiently described.

Additionally, reference may be made to variables, such as, “a”, “b”, “c”, which are used to denote components where more than one component may be implemented. It is important to note, that there need not necessarily be multiple components and further, where multiple components are implemented, they need not be identical. Instead, use of variables to reference components in the figures is done for convenience and clarity of presentation.

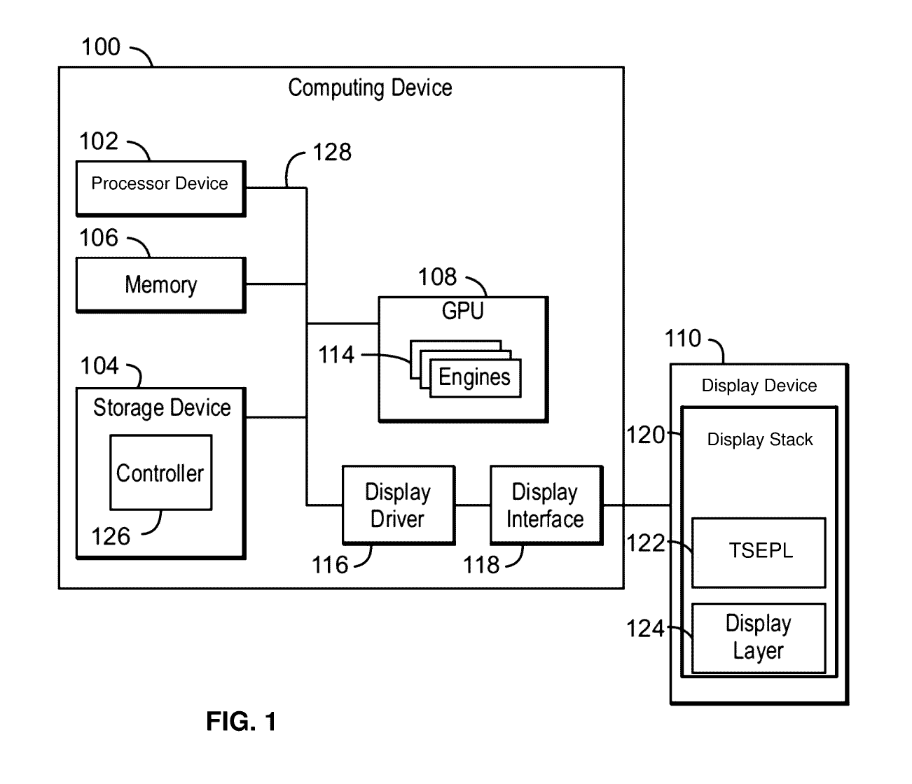

FIG. 1 illustrates a block diagram of a computing device 100 configured with a touch sensitive electrostatic privacy layer (TSEPL). In particular, the device 100 of this figure is configured to both restrict light propagation associated with a display device and to register a touch event. The computing device 100 may be, for example, a laptop computer, a desktop computer, an Ultrabook, a tablet computer, a mobile device, a server, a TV, a Smart-TV, a home automation device (e.g., a control panel, a thermostat, or the like), a wearable computing device (e.g., a watch, glasses, or the like), or the like. The computing device 100 may include a processor device 102 configured to execute stored instructions, as well as a storage device 104 including a non-transitory computer-readable medium, and a memory device 106.

The computing device 100 may also include a graphics processing unit (GPU) 108. In some cases, the GPU 108 is embedded in the processor device 102. In other cases, the GPU 108 may be a discrete component relative to the processor device 102. The GPU 108 may include a cache, and can be configured to perform any number of graphics operations within the computing device 100. For example, the GPU 108 may be configured to render or manipulate graphics images, graphics frames, videos, or the like, to be displayed to a user of the computing device 100 at a display device 110. Displaying image data may be carried out by one or more engines 114 of the GPU 108, a display driver 116, a display interface 118, and the like.

The display device 110 may be implemented as an external display device to the computing device 100, as an internal display device to the computing device 100, or any combination thereof. In any case, the display device may include a display stack 120 including a number of components arranged to form the display. For example, the display stack 120 may include at least a TSEPL 122 and a display layer 124. The display layer 124 may be a component of a display screen configured to emit light, such as a light emitting diode (LED) display, a liquid crystal display, an electronic paper display, an organic LED (OLED) display, a plasma display, or the like. It is noted, that many display stacks will include other components or layers not depicted here, such as, for example, backlights, covers (e.g., back cover, cover glass, or the like) filters, diffusive layers, pressure layers, tape layers, adhesive layers, light guide panel layers, etc. Examples are not limited in this context.

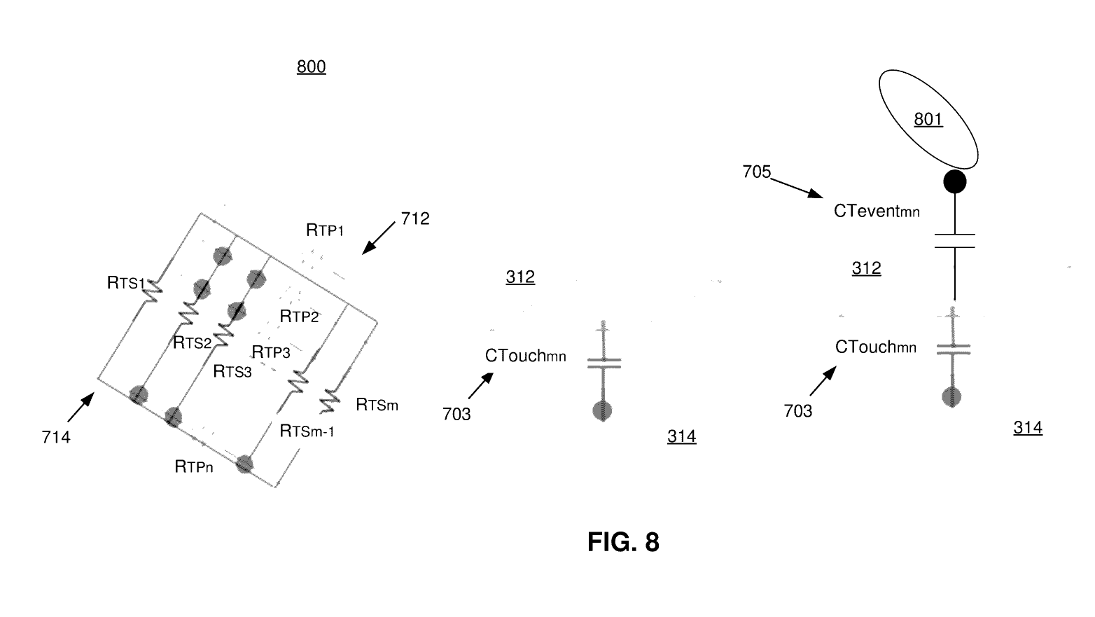

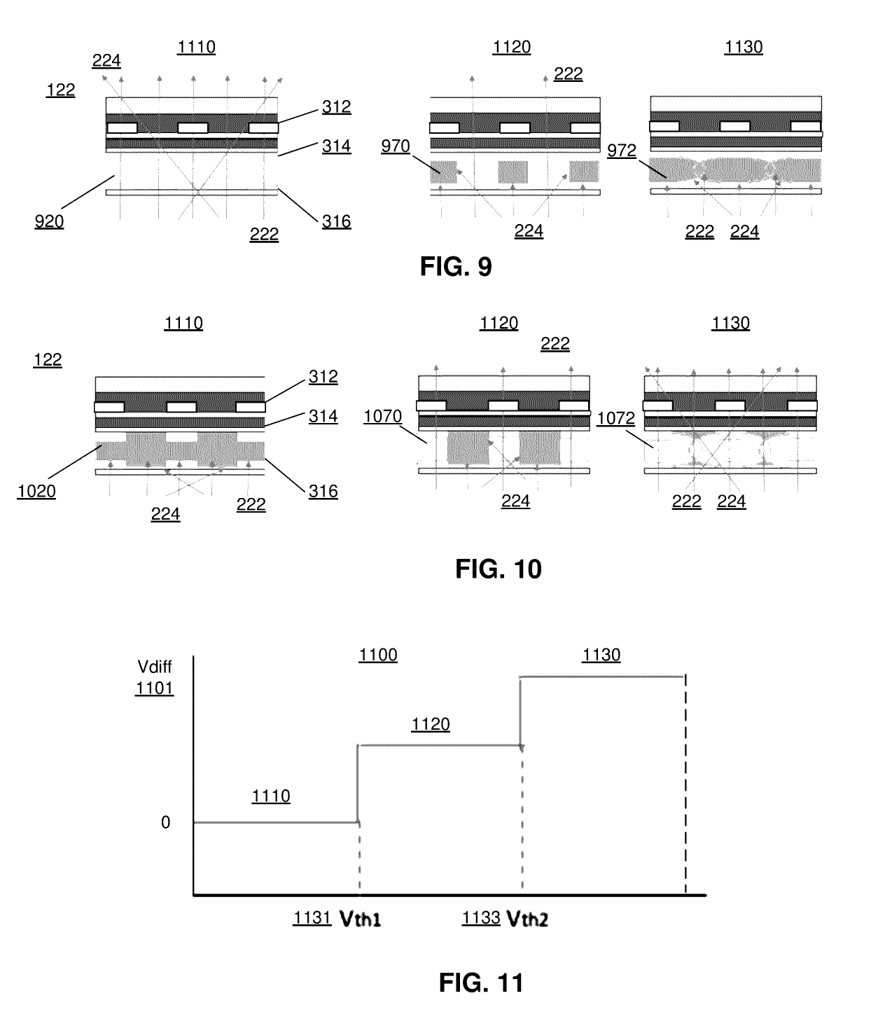

The TSEPL 122 may be composed of a number of touch layer electrodes and top and bottom privacy layer electrodes, as well as a dielectric material disposed between the top and bottom privacy layer electrodes. In some examples, the dielectric material may be optically anisotropic birefringence polymer, an electrically anisotropic dielectric polymer, or an optically anisotropic birefringence and electrically anisotropic dielectric polymer. Examples of the TSEPL 122 are given in greater detail below. In general, however, the TSEPL 122 may be configured to register a touch by scanning the touch layer electrodes for changes in capacitance (e.g., due to a user's finger, a stylus, etc.). In particular, the touch layer electrodes may be configured to cooperate with the top privacy layer electrodes and to form multiple points of “mutual” capacitance there between (refer to FIG. 8). Furthermore, the TSEPL may be configured to have a “privacy mode” and a “transparent mode.” In particular, the TSEPL may be configured such that a voltage differential between the top and bottom privacy layer electrodes may cause micro louvers (refer to FIGS. 9 to 10) to turn “on” and “off” to restrict a propagation direction of light emitted from the display layer 124 of the display stack 120.

In some cases, the TSEPL 122 may be controlled by a controller 126. The controller 126 may be implemented as logic, a portion of which may include hardware logic. In other cases, the controller 126 may be implemented as a portion of software stored in the storage device 104, as software or firmware instructions of the display driver 116, the display interface 118, the engines 114 of the GPU 108, the processor device 102, any other suitable controller, or any combination thereof. In yet other cases, the controller 126 may be implemented as electronic logic, at least partially comprising hardware logic, to be carried out by electronic circuitry, circuitry to be carried out by an integrated circuit, or the like. The controller 126 may be configured to operate independently, in parallel, distributed, or as part of a broader process. In yet other cases, the controller 126 may be implemented as a combination of software, firmware, hardware logic, and the like. In general, the controller 126 may be configured to control the TSEPL 122, to register touch events, and to activate various modes (e.g., privacy, transparent, etc.) that are described in greater detail below. The controller may be operably coupled to a voltage source and configured to send a control signal to the voltage source including an indication of an amount of voltage to be applied to portions (e.g., the electrodes discussed in greater detail below, etc.) of the TSEPL 122. It is noted, that in some examples, multiple controllers 126 (not depicted) may be provided. In particular, a controller could be provided to control the touch aspect of the TSEPL 122 while another controller could be provided to control the privacy aspect of the TSEPL 122.

The memory device 106 can include random access memory (RAM), read only memory (ROM), flash memory, or any other suitable memory systems. For example, the memory device 106 may include dynamic random access memory (DRAM). The memory device 106 can include random access memory (RAM) (e.g., static random access memory (SRAM), dynamic random access memory (DRAM), zero capacitor RAM. Silicon-Oxide-Nitride-Oxide-Silicon SONOS, embedded DRAM, extended data out RAM, double data rate (DDR) RAM, resistive random access memory (RRAM), parameter random access memory (PRAM), etc.), read only memory (ROM) (e.g., Mask ROM, programmable read only memory (PROM), erasable programmable read only memory (EPROM), electrically erasable programmable read only memory (EEPROM), etc.), flash memory, or any other suitable memory systems.

The processor device 102 may be a main processor that is adapted to execute the stored instructions. The processor device 102 may be a single core processor, a multi-core processor, a computing cluster, or any number of other configurations. The processor device 102 may be implemented as Complex Instruction Set Computer (CISC) or Reduced Instruction Set Computer (RISC) processors, x86 Instruction set compatible processors, multi-core, or any other microprocessor or central processing unit (CPU). The processor device 102 may be connected through a system bus 128 (e.g., Peripheral Component Interconnect (PCI). Industry Standard Architecture (ISA), PCI-Express, HyperTransport®, NuBus, etc.) to components including the memory 106 and the storage device 104. The processor device 102 may also be linked through the bus 128 to the display driver 116 and the display interface 118 and configured to connect the computing device 100 to the display device 110 via the display interface 118.

In some cases, the computing device 100 may be a mobile computing device. In some cases, the display device 110 may be a mobile display device to a mobile computing device. As noted above, the display device 110 may be incorporated into the computing device 100 and/or may be separate from the computing device 100.

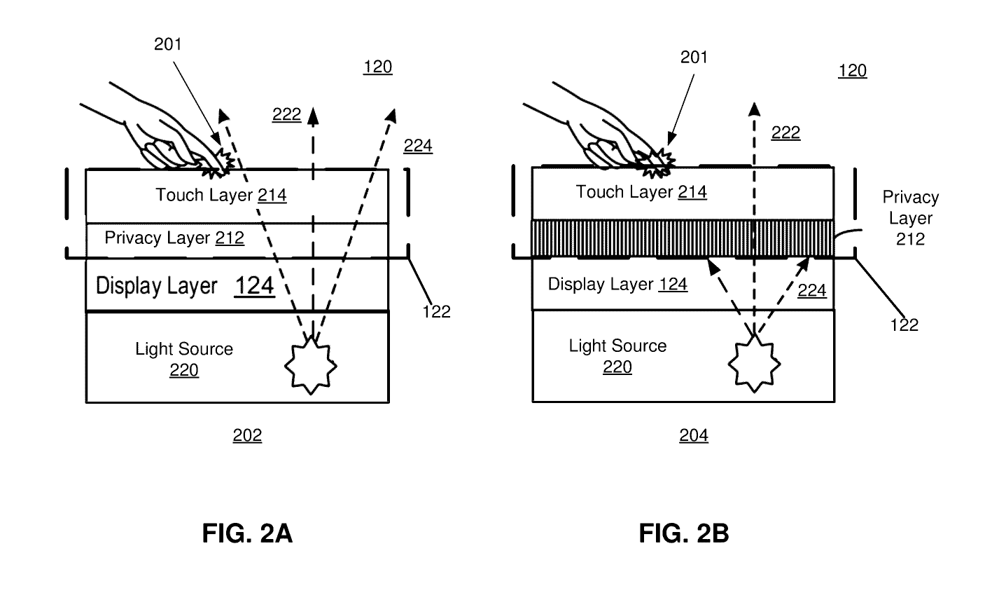

FIGS. 2A-2B illustrate block diagrams of a side view of an example embodiment of the display stack 120 including the TSEPL 122. As depicted, the TSEPL 122 may include both an active privacy layer 212 and a touch layer 214. Furthermore, these figures depict the TSEPL 122 registering a touch event 201 during a transparent mode 202 and a privacy mode 204. Specifically, FIG. 2A depicts the touch layer 214 registering the touch event 201 while the active privacy layer 212 is configured to allow both on-angle and off-angle light emitted from the display layer 124 to pass through the TSEPL 122 while FIG. 2B depicts the touch layer 214 registering the touch event 201 when the active privacy layer 212 is configured to allow on-angle light emitted from the display layer 124 to pass through the TSEPL 122 but to inhibit off-angle light emitted from the display layer 124 from passing through the TSEPL 122.

Turning more specifically to FIG. 2A, the display stack 120 is depicted with the display layer 124 disposed below the TSEPL 122. The display layer 124 can also include a light source 220. It is to be appreciated, that the display layer 120 and the light source 220 may correspond to a variety of different display technologies, such as, for example, OLED, backlit LCD, plasma, or the like. As such, the depiction herein of the light source 220 and the display layer 120 is not to be limiting, but is instead simplified to show on-angle light 222 and off-angle light 224 emitted from the display layer 120.

During the transparent mode 202, both the on-angle light 222 and the off-angle light 224 may pass through the TSEPL 122 substantially uninhibited. Furthermore, the touch screen functionality of the TSEPL 122 may also be substantially uninhibited. More specifically, the touch layer 214 of the TSEPL 122 may register the touch event 201 while the privacy layer 212 of the TSEPL 122 may be configured to for the transparent mode 202.

Turning more specifically to FIG. 2B, the display stack 120 described with respect to FIG. 2A is depicted in the privacy mode 204. In particular, the on-angle light 222 emitted from the display layer 120 and the light source 220 may pass through the privacy layer 212 of the TSEPL 122 while the off-angle light 224 may be inhibited from passing through the privacy layer 212. More specifically, the dielectric material (refer to FIGS. 9 to 10) may be configured to either turn on or off micro louvers to absorb and diffuse the off-angle light 224 or to allow the on angle light 222 to pass. Furthermore, as depicted, the privacy mode 204 may be activated by the privacy layer 212 of the TSEPL 122 while the touch layer 214 of the TSEPL 122 registers the touch event 201.

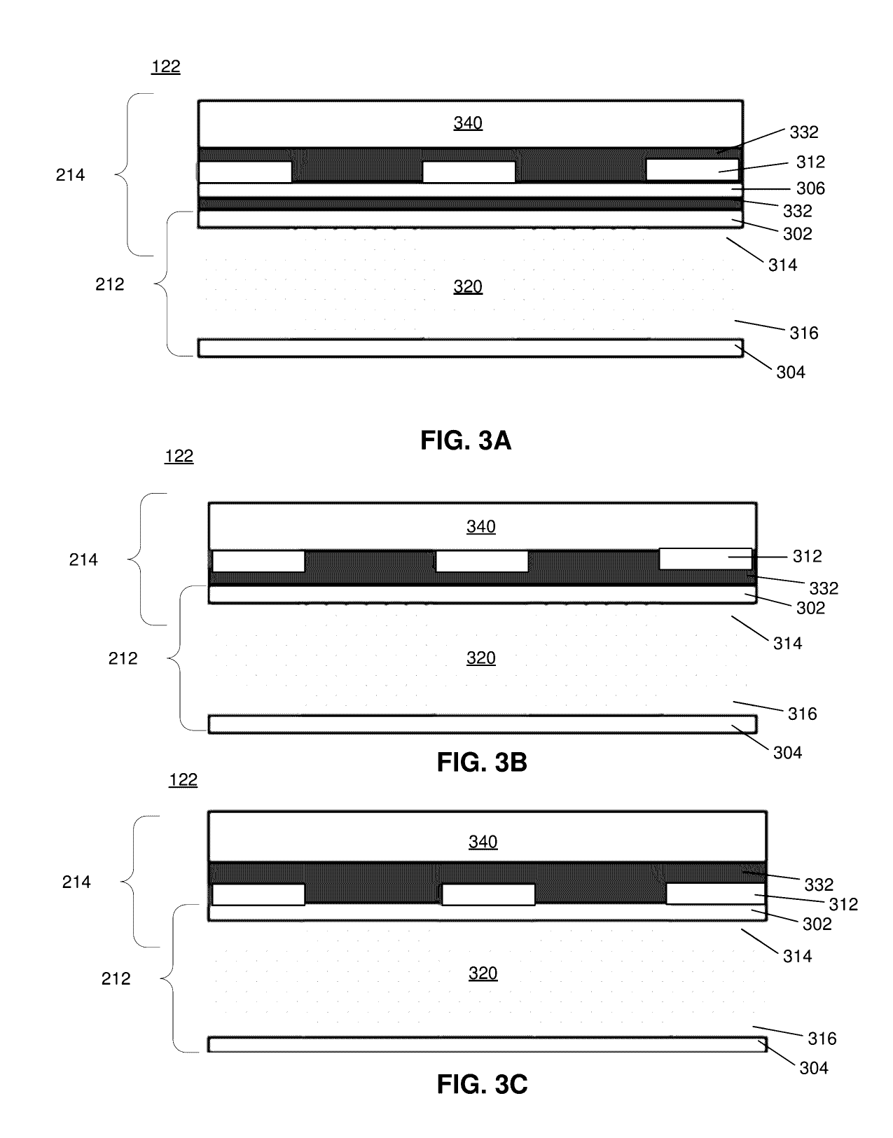

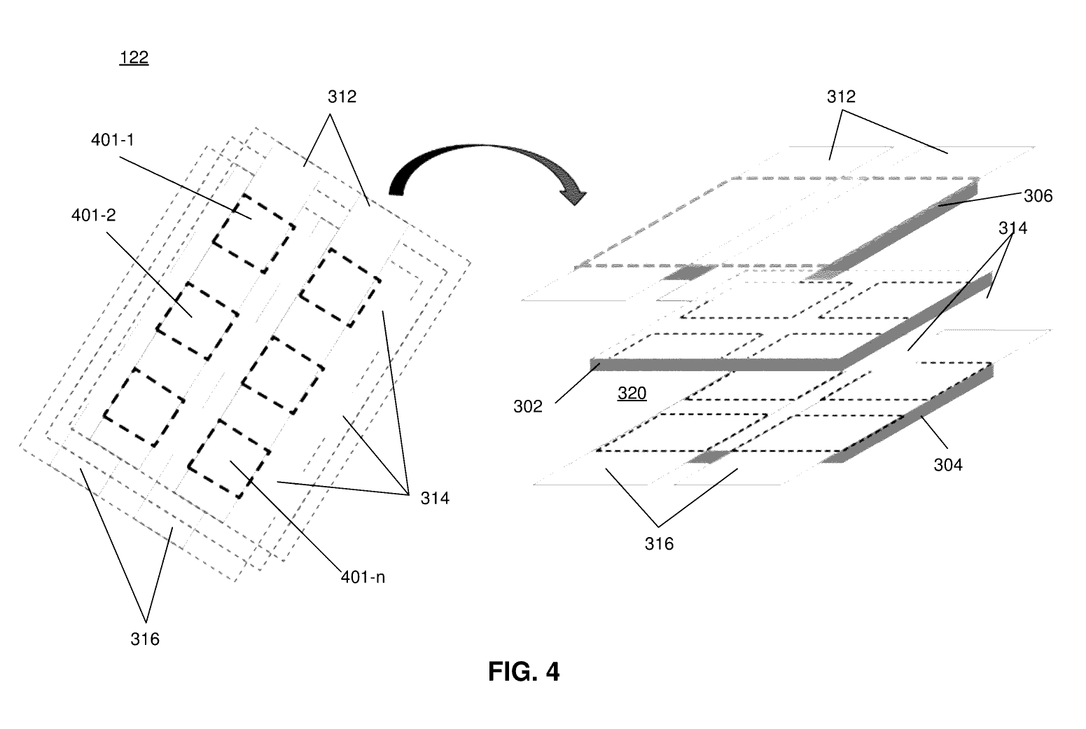

FIGS. 3A-3C illustrate block diagrams of various example embodiments of the TSEPL 122 depicted from a side cut-away view. In general, these figures depict both the privacy layer 212 and the touch layer 214 of the TSEPL 122. Additionally, these figures depict a number of touch layer electrodes 312, a number of top privacy layer electrodes 314, and a number of bottom privacy layer electrodes 316 as well as a dielectric material 320 disposed between the top and bottom electrodes 314 and 316. In general, the privacy layer 212 may include both a transparent top plate and a transparent bottom plate, where each of the transparent plates have a first and a second surface (refer to FIGS. 4 to 6). The bottom privacy layer electrodes 316 are disposed on the first (e.g., “upper”) surface of the transparent bottom plate 304 while the top privacy layer electrodes 314 are disposed on the second (e.g., “lower”) surface of the transparent top plate 302. The top and bottom plates with the respective electrodes are disposed such that the dielectric material 320 is between the plates with the electrodes proximate to the dielectric material. The touch layer 214 is disposed on the privacy layer 212. It is important to note, that the touch layer 214 includes the transparent top plate 302 and the top privacy layer electrodes 314 of the privacy layer 212. Said differently, the touch layer 214 and the privacy layer 212 share some components.

It is noted, that the number of electrodes depicted in these figures is shown at a number to facilitate understanding and preserve clarity. However, in practice, a TSEPL, such as the TSEPL 122, may be implemented with any number of electrodes. Examples are not limited in this context. Furthermore, the TSEPL 122 may be implemented with dielectric material 320 including various polymers that can be switched to absorb and/or diffuse off-angle light incident on the portion of the polymer that is activated. For example, the dielectric material 320 may be optically anisotropic birefringence polymer, an electrically anisotropic dielectric polymer, or an optically anisotropic birefringence and electrically anisotropic dielectric polymer. In some examples, the polymer may be configured such that off-angle viewing of the display device results in a colored (e.g., gray, red, black, blue, or the like) display. Examples are not limited in this context.

Turning more specifically to FIG. 3A, a first example of the TSEPL 122 is illustrated. As depicted, the TSEPL 122 includes the transparent top plate 302 and the transparent bottom plate 304 with the top electrodes 314 and the bottom electrodes 316 arranged as described above. Additionally, the dielectric material 320 is depicted. The touch layer 214 may include a transparent substrate 306 having a first and second surface. The touch layer electrodes 312 may be disposed on a first (e.g., “upper”) surface of the transparent substrate 306. The transparent substrate 306 may be disposed on the transparent top plate 302. In particular, the first (e.g., “upper”) surface of the transparent top plate 302 may be proximate to the second (e.g., “lower”) surface of the transparent substrate 306. With some examples, the substrate 306 and plate 302 may be attached using a transparent adhesive or resin 332 (e.g., optically clear adhesive (OCA), optically clear resin (OCR), or the like). Furthermore, the touch layer 214 may include a protective cover 340 (e.g., transparent material, glass, plastic, or the like), which may be attached to the touch layer electrodes via another transparent adhesive or resin 332.

Turning more specifically to FIG. 3B, a second example of the TSEPL 122 is illustrated. As depicted, the TSEPL 122 includes the transparent top plate 302 and the transparent bottom plate 304 with the top electrodes 314 and the bottom electrodes 316 arranged as described above. Additionally, the dielectric material 320 is depicted. The touch layer 214 may include the cover 340. The touch layer electrodes 312 may be disposed on a second (e.g., “lower”) surface of the cover 340. The cover 340 may be disposed on the transparent top plate 302. In particular, the first (e.g., “upper”) surface of the transparent top plate 302 may be proximate to the second (e.g., “lower”) surface of the cover 340. Said differently, the touch layer electrodes 312 may be disposed proximate to the first surface of the top plate 302. With some examples, the cover 340 and plate 302 may be attached using the transparent adhesive or resin 332.

Turning more specifically to FIG. 3C, a third example of the TSEPL 122 is illustrated. As depicted, the TSEPL 122 includes the transparent top plate 302 and the transparent bottom plate 304 with the top electrodes 314 and the bottom electrodes 316 arranged as described above. Additionally, the dielectric material 320 is depicted. The touch electrodes 312 of the touch layer 214 may be disposed on the first (e.g., “upper”) surface of the transparent top plate 302. Additionally, the touch layer 214 may include the cover 340, which may be disposed over the touch layer electrodes 312, for example, using the transparent adhesive or resin 332.

FIGS. 4 to 6 illustrate portions of the example TSEPLs 122 illustrated in FIGS. 3A to 3C, respectively. It is noted, that the examples are depicted in a plan view perspective to better illustrate the arrangement of the electrodes and discuss points where touch event(s) (e.g., the touch event 201 depicted in FIGS. 2A and 2B) may be recognized. In general, the touch layer electrodes 312 cooperate with the top privacy layer electrodes 314 to form points (e.g., the points 401-1 to 401-n) where a capacitance is formed between the electrodes. As such, when a touch event occurs, the capacitance may change and be detected by. More particularly, due to the touch event, a second capacitance may form between the point and the object (e.g., finger, stylus, or the like) associated with the touch event. As a result, the capacitance between the touch layer electrode and the top privacy layer electrode may change. This is often referred to as “mutual capacitance.” Examples of scanning the electrodes to detect touch events as well as driving the electrodes to activate or de-activate the privacy aspects of the TSEPL 122 will be described in greater detail below.

It is important to note, that the electrodes are depicted crossing in a geometric pattern, specifically, a particular set of electrodes are depicted approximately perpendicular to an adjacent set of electrodes. However, it is noted, that the present TSEPL may be implemented with electrodes arranged in a variety of geometric patterns, for example, diagonally, or the like. Examples are not limited in this context.

Turning more specifically to FIG. 4, the TSEPL 122 is depicted showing a number of bottom privacy layer electrodes 316 disposed on the transparent bottom plate 304. In particular, the bottom layer electrodes 316 are disposed substantially parallel to each other along the surface of the transparent bottom plate 304. Additionally, a number of top privacy layer electrodes 314 are depicted disposed on the transparent bottom plate 302. In particular, the top layer electrodes 314 are disposed substantially parallel to each other along the bottom surface of the transparent top plate 302. However, as illustrated, the top electrodes 314 may be substantially perpendicular to the bottom electrodes 316. Furthermore, the dielectric material 320 is depicted between the top and bottom electrodes. Additionally, the touch layer electrodes 312 are depicted disposed on the transparent substrate 306. In particular, the touch layer electrodes 312 are disposed substantially parallel to each other along the surface of the transparent substrate 306. It is noted, that the touch layer electrodes 312 are disposed substantially parallel to the bottom privacy layer electrodes 316 and substantially perpendicular to the top privacy layer electrodes 314. Accordingly, points 401-1 to 401-n may be formed at each crossing between the electrodes. These points may be used to detect a touch event and also to form micro louvers to activate and de-activate the privacy aspects of the TSEPL 122 as described herein.

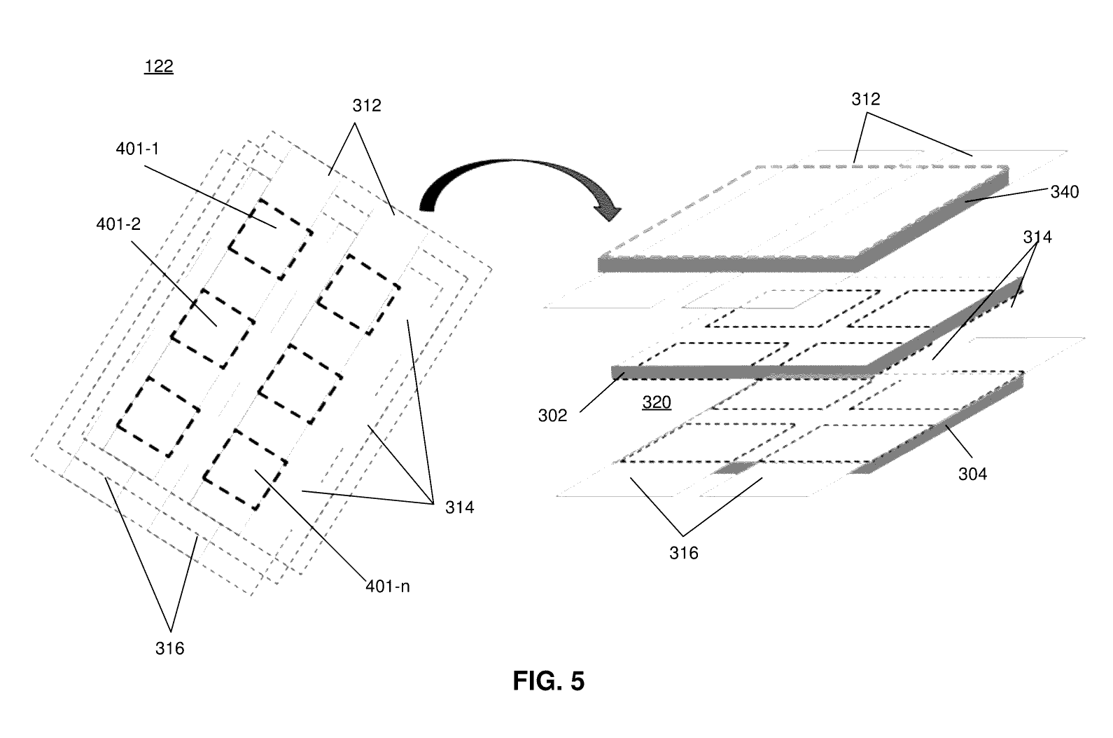

Turning more specifically to FIG. 5, the TSEPL 122 is depicted showing the bottom privacy layer electrodes 316, the transparent bottom plate 304, the top privacy layer electrodes 314, the transparent top plate 302, and the dielectric material 320 as described above in FIG. 4. Additionally, the touch layer electrodes 312 are depicted disposed on the cover 340. In particular, the touch layer electrodes 312 are disposed substantially parallel to each other along the bottom surface of the cover 340. It is noted, that like in FIG. 4, the touch layer electrodes 312 are disposed substantially parallel to the bottom privacy layer electrodes 316 and substantially perpendicular to the top privacy layer electrodes 314. Accordingly, points 401-1 to 401-n may be formed at each crossing between the electrodes. These points may be used to detect a touch event and also to form micro louvers to activate and de-activate the privacy aspects of the TSEPL 122.

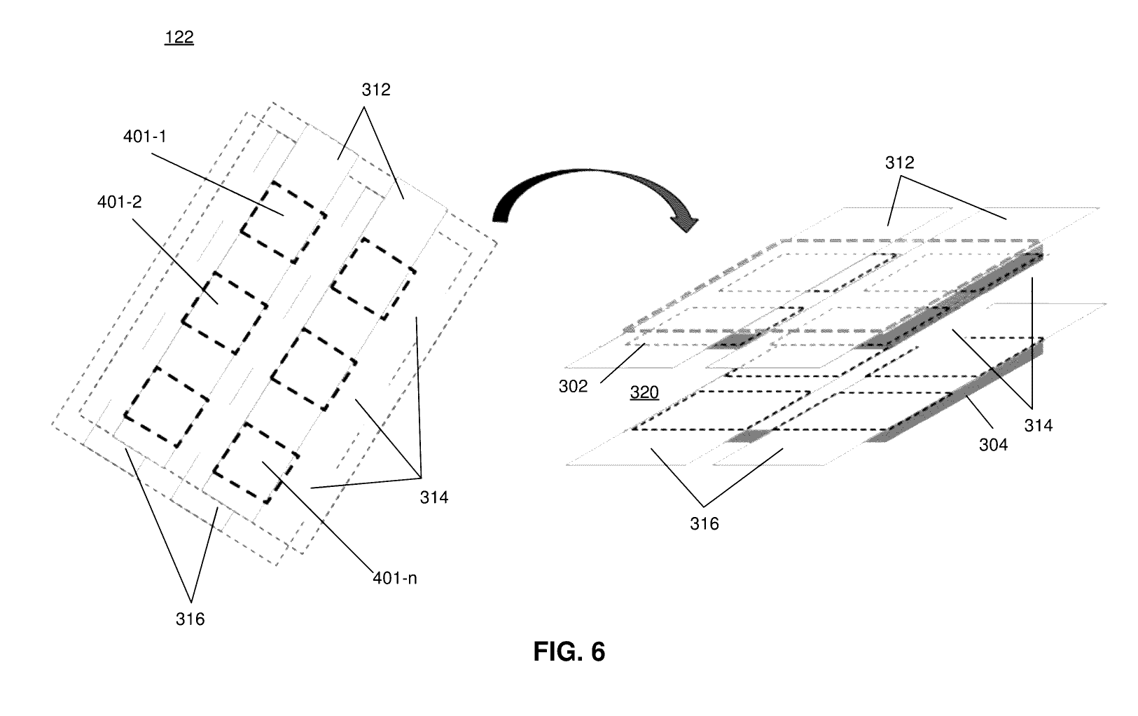

Turning more specifically to FIG. 6, the TSEPL 122 is depicted showing the bottom privacy layer electrodes 316, the transparent bottom plate 304, the top privacy layer electrodes 314, the transparent top plate 302, and the dielectric material 320 as described above in FIG. 4. Additionally, the touch layer electrodes 312 are depicted disposed on the transparent top plate 302. In particular, the touch layer electrodes 312 are disposed substantially parallel to each other along the top surface of the transparent top plate 302. It is noted, that like in FIGS. 4 and 5, the touch layer electrodes 312 are disposed substantially parallel to the bottom privacy layer electrodes 316 and substantially perpendicular to the top privacy layer electrodes 314. Accordingly, points 401-1 to 401-n may be formed at each crossing between the electrodes. These points may be used to detect a touch event and also to form micro louvers to activate and de-activate the privacy aspects of the TSEPL 122.

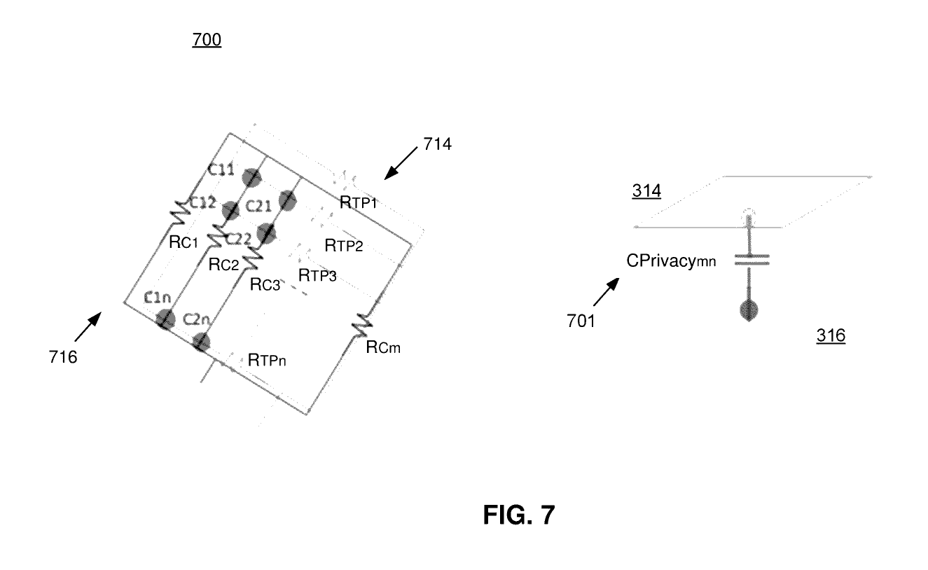

FIGS. 7 and 8 depict equivalent circuits for the arrangement of electrodes depicted in FIGS. 3A to 3C and 4 to 6. In general, the electrodes behave as a resistance and under an applied voltage, a capacitance forms between adjacent (e.g., top and bottom or touch and top) resistances. For example, FIG. 7 illustrates a circuit 700 corresponding to a set of top electrodes disposed perpendicular to a set of bottom electrodes. For an example, in a privacy layer 212 of the TSEPL 122. Each of the top electrodes are represented by a resistance (R_{TPN}) 714 while each of the bottom electrodes are represented by a resistance (R_{CM}) 716. Micro louvers (e.g., refer to FIGS. 9 to 10) form in areas where a top resistance 714 (e.g., top electrode 314) crosses a bottom resistance 716 (e.g., bottom electrode 316), represented by capacitances (CPrivacy_{MN}) 701. Furthermore, voltage source 790 is depicted applying a voltage to the circuits 700. In some examples, the voltage source 790 may be operably coupled to the controller 126 to receive control signal from the controller to include indications of a voltage to apply to the electrodes.

FIG. 8 illustrates a circuit 800 corresponding to a set of touch layer electrodes disposed perpendicular to a set of top electrodes. For example, as in a touch layer 214 of the TSEPL 122. Each of the touch electrodes are represented by a resistance (R_{TSM}) 712 while each of the top electrodes are represented by a resistance (R_{TM}) 714. A capacitance forms in areas where a touch resistance 712 (e.g., touch layer electrodes 312) crosses a top resistance 714 (e.g., top electrodes 314), represented by capacitances (CTouch_{MN}) 703. Additionally, during a touch event (e.g., a touch event 201, or the like), a capacitance 705 (CTevent_{MN}) 705 is formed between a charge holding object 801 (e.g., finger, stylus, or the like) and one of the touch resistances 712 (e.g., the touch layer electrodes 312). As such, the touch event may be detected (e.g., based on mutual capacitance, or the like) by scanning the touch sensor electrodes for changes in capacitance. Furthermore, voltage source 890 is depicted applying a voltage to the circuits 800. In some examples, the voltage source 790 may be operably coupled to the controller 126 to receive control signal from the controller to include indications of a voltage to apply to the electrodes. In some examples, the voltage sources 790 and 890 may be the same voltage source.

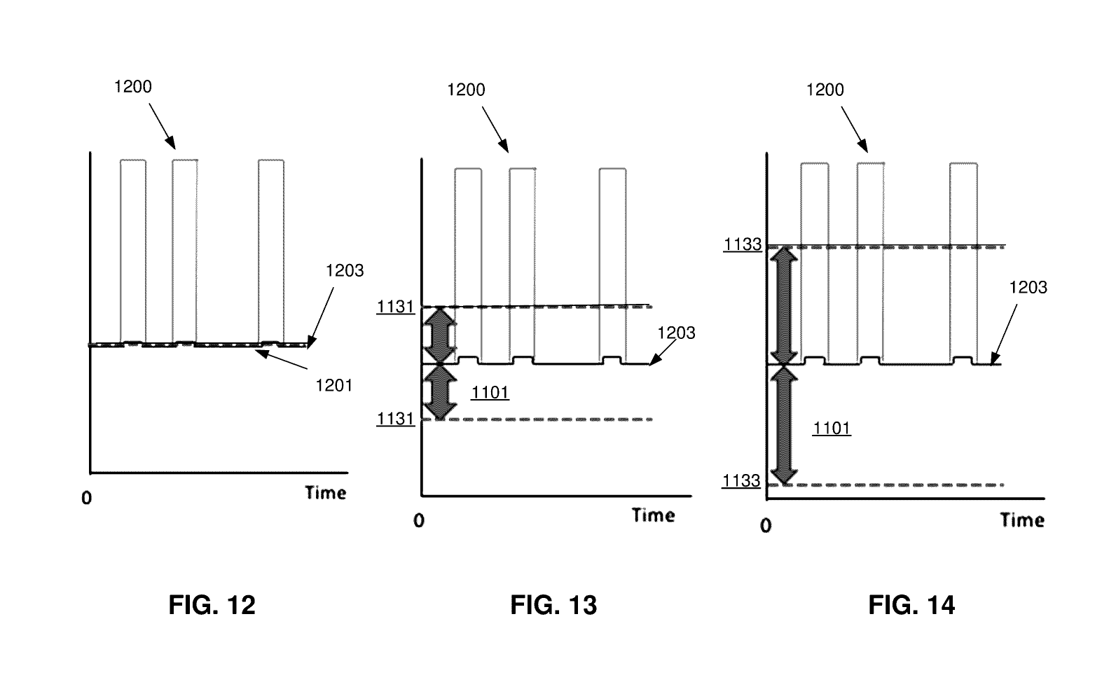

FIGS. 9-14 depict examples of the voltage driving schemes for both the privacy portion 212 and the touch portion 214 of the TSEPL 122. As evidenced by the example TSEPLs 122 described above, integration of touch portion 214 with the privacy portion 212, versus a conventional display stack, can improve mechanical specifications, for example thickness, Z height, and weight. Furthermore, the TSEPL 122 can improve optical performance, for example, transmittance, haze and color shift. Furthermore, it is noted, that the TSEPL 122 of the present disclosure may be implemented with various driving schemes for the privacy component and scanning schemes for the touch component such that interference between the top electrodes, which is shared between both the privacy portion 212 and the touch portion 214 may be minimized. In particular, with some examples, a scanning frequency (e.g., for mutual capacitance based touch screens, or the like) may be between 100 KHz to 200 Khz, or higher. A reporting rate for detection of touch events (e.g., the event 201, or the like) may be between 60 Hz to 120 hz, or higher. Assuming a reporting rate of 120 Hz for 100 touch channels (e.g., touch sensor electrodes 312 and top electrodes 314, or the like) a single frame period may be 8.3 m seconds. Further assuming 100 KHz scanning frequency, a single touch sensor channel scanning period is 83 u seconds. As will be explained in greater detail below, a voltage is pulsed on each touch sensor channel to measure the capacitance to detect a touch event. For example, using the assumptions detailed above, each channel may be pulsed for a period of 83 u seconds. As will be described in greater detail below, this may be insufficient to interference with the operation of the privacy component 212 of the TSEPL 122. A voltage driving scheme for the privacy component 212 of the TSEPL 122 is described with reference to FIGS. 9 to 11 while a voltage scanning scheme for the touch sensor component 214 of the TSEPL 122 is described with reference to FIGS. 12 to 14.

FIGS. 9 and 10 illustrate two examples of a TSEPL 122. In general, FIG. 9 illustrates the TSEPL 122 having a dielectric material 920 that does not substantially inhibit transmission of light unless micro-louvers are formed as described herein while FIG. 10 illustrates the TSEPL 122 having a dielectric material 1020 that does substantially inhibit the transmission of light unless micro-louvers are formed as described herein. These figures will be described with reference to FIG. 11. FIG. 11 illustrates graph of a voltage signal 1100 having different amplitudes. These amplitudes may correspond to an applied voltage differential 1101 between the bottom privacy layer electrodes 316 and the top privacy layer electrodes 314. For example, the top privacy layer electrodes 314 may be common or electrically coupled to a common or ground reference voltage while the bottom privacy layer electrodes 316 may have a voltage applied thereto by a power supply 910 to form the voltage differential 1101 between the top and bottom electrodes. In particular, these amplitude or amount of voltage differential between the electrodes may be different for different modes operation. For example, a mode 1110, a second mode 1120, and a third mode 1130 are shown having different voltage differentials. With some examples, the bottom electrodes 316 may be “common” or “ground” while the top electrodes 314 may have a voltage applied thereto

Turning more specifically to FIG. 9, an example of the TSEPL 122 having a dielectric material 920 that does not inhibit transmission of light in an “unbiased” state is depicted. Said differently, the on-angle light 222 and the off-angle light 224 passes through the dielectric material 920 during the first mode 1110. As described above, during the first mode 1110, the voltage differential between the top electrodes 314 and the bottom electrodes 316 may be substantially zero. In some examples, the voltage differential between the top and bottom electrodes during the first mode 1110 is less than a first voltage threshold (Vth) 1131.

During the second mode 1120, the voltage differential between the top electrodes 314 and the bottom electrodes 316 may be greater than zero. In some examples, the voltage differential between the top and bottom electrodes during the second mode 1120 is greater than the first voltage threshold (Vth1) 1131 but less than a second voltage threshold (Vth2) 1133. In particular, the voltage differential between the top and bottom plates during the second mode 1120 is sufficient to cause the dielectric 920 to bias between the top and bottom electrodes (e.g., refer to FIG. 7) to form micro louvers 970. The micro louvers block incident light. As such, off-angle light 224 may be substantially inhibited from passing through the dielectric material 920. As a result, only on-angle light 222 may be visible from the TSEPL 122.

During the third mode 1130, the voltage differential between the top electrodes 314 and the bottom electrodes 316 may be greater than the voltage differential during the second mode 1120. In some examples, the voltage differential between the top and bottom electrodes during the second mode 1130 is greater than the second voltage threshold (Vth2) 1133. In particular, the voltage differential between the top and bottom plates during the second mode 1120 is sufficient to cause the dielectric 920 to bias between the top and bottom electrodes (e.g., refer to FIG. 7) to form micro louvers 972 that block both on-angle light 222 and off-angle light 224. As a result, substantially all light may be blocked by the TSEPL 122.

Turning more specifically to FIG. 10, an example of the TSEPL 122 having a dielectric material 1020 that inhibits transmission of light in an “unbiased” state is depicted. Said differently, both on-angle light 222 and off-angle light 224 is blocked by the dielectric material 1020 during the first mode 1110. As described above, during the first mode 1110, the voltage differential between the top electrodes 314 and the bottom electrodes 316 may be substantially zero. In some examples, the voltage differential between the top and bottom electrodes during the first mode 1110 is less than a first voltage threshold (Vth) 1131.

During the second mode 1120, the voltage differential between the top electrodes 314 and the bottom electrodes 316 may be greater than zero. In some examples, the voltage differential between the top and bottom electrodes during the second mode 1120 is greater than the first voltage threshold (Vth1) 1131 but less than a second voltage threshold (Vth2) 1133. In particular, the voltage differential between the top and bottom plates during the second mode 1120 is sufficient to cause the dielectric 920 to bias between the top and bottom electrodes (e.g., refer to FIG. 7) to form micro louvers 1070. The micro louvers transmit incident light. As such, off-angle light 224 may be substantially inhibited from passing through the dielectric material 1020. As a result, only on-angle light 222 may be visible from the TSEPL 122.

During the third mode 1130, the voltage differential between the top electrodes 314 and the bottom electrodes 316 may be greater than the voltage differential during the second mode 1120. In some examples, the voltage differential between the top and bottom electrodes during the second mode 1130 is greater than the second voltage threshold (Vth2) 1133. In particular, the voltage differential between the top and bottom plates during the second mode 1120 is sufficient to cause the dielectric 920 to bias between the top and bottom electrodes (e.g., refer to FIG. 7) to form micro louvers 1072 that transmit both on-angle light 222 and off-angle light 224. As a result, substantially all light may be transmitted by the TSEPL 122.

As described, the privacy component, and particularly, the different modes (e.g., 1110, 1120, 1130, or the like) may be controlled by changing the voltage differential between the top and bottom electrodes 314 and 316. In some examples, the controller 126 may be configured control a power supply or the like operably coupled to the electrodes 314 and 316 to control the voltage differential and change modes.

Turning now to FIGS. 12 to 14, a graph showing voltage pulses for scanning channels of the touch sensor components are described. In particular, a voltage signal 1200 is depicted showing a series of voltage pulses used to scan (e.g., measure capacitance on a touch channel such as a touch sensor electrode 312) to detect a touch event on a touch channel. In general, FIGS. 12 to 14 illustrate the voltage signal 1200 during the modes 1110, 1120, and 1130 depicted in FIGS. 9 to 11. It is important to note, that FIGS. 12-14 are described with reference to the TSEPL 122 depicted with respect to FIGS. 3A and 4, however, it is to be appreciated that the other example TSEPL configurations (e.g., FIGS. 3B-3C and 5-6, or the like) may be operably coupled to a power source and controlled as described herein with respect to FIGS. 12-14.

As illustrated in FIG. 12, the voltage signal 1200 is depicted during the first mode 1110. As illustrated during the first mode 1110, the differential 1101 between the top electrode voltage 1203 bottom electrode voltage 1201 is substantially zero. As depicted, the short pulses of the voltage signal 1200 are insufficient to cause the voltage differential to raise to the voltage first threshold as required to cause the privacy mode to change from the first mode 1110 to the second mode 1120.

Turning to FIG. 13, the voltage signal 1200 is depicted during the second mode 1120. As illustrated during the second mode 1120, the differential 1101 between the top electrode voltage 1203 bottom electrode voltage 1 is approximately equal to or greater than the first voltage threshold 1131. Furthermore, as illustrated, the short pulses of the voltage signal 1200 are insufficient to cause the voltage differential to raise above the voltage first threshold as required to cause the privacy mode to change from the second mode 1120 to the third mode 1130.

Turning to FIG. 14, the voltage signal 1200 is depicted during the third mode 1120. As illustrated during the third mode 1130, the differential 1101 between the top electrode voltage 1203 bottom electrode voltage 1201 is approximately equal to or greater than the second voltage threshold 1133. Furthermore, as illustrated, the short pulses of the voltage signal 1200 are insufficient to cause the voltage differential to substantially deviate from the second first threshold as required to cause the privacy mode to change from the third mode 1130.

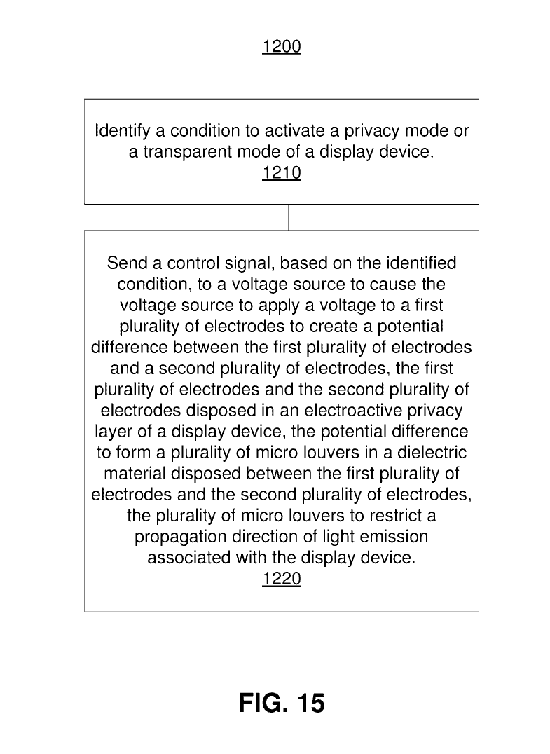

FIG. 15 illustrates a logic flow 1500 for configuring a privacy mode or a transparent mode (e.g., modes 1110, 1120, 1130, or the like) of a display device including a TSEPL as described herein. In some examples, the method 1500 may be implemented by the controller 126 described above. However, embodiments are not limited in this context. The logic flow 1500 may begin at block 1510. At block 1510 “identify a condition to activate a privacy mode or a transparent mode of a display device,” the controller 126 may identify a condition, such as, displayed media and a corresponding privacy mode or transparent mode desired for the displayed media.

Continuing to block 1520 “send a control signal, based on the identified condition, to a voltage source to cause the voltage source to apply a voltage to a first plurality of electrodes to create a potential difference between the first plurality of electrodes and a second plurality of electrodes, the first plurality of electrodes and the second plurality of electrodes disposed in an electroactive privacy layer of a display device, the potential difference to form a plurality of micro louvers in a dielectric material disposed between the first plurality of electrodes and the second plurality of electrodes, the plurality of micro louvers to restrict a propagation direction of light emission associated with the display device,” the controller may send a control signal to a voltage source (e.g., the voltage source 790, or the like). The control signal to include an indication to apply voltage to electrodes in the EPL to cause the TSEPL to form (or not form as may be the case) micro louvers.

Continuing to block 1530 “send another control signal to a voltage source to cause the voltage source to apply a series of voltage pulses to a touch layer electrode to measure a change in capacitance of the touch layer electrode, the touch layer electrode operatively coupled one of the first plurality of electrodes to form a capacitance there between” the controller may send another control signal to a voltage source (e.g., the voltage source 890, or the like). The control signal to include an indication to apply a series of voltage pulses to the touch layer electrodes to measure a capacitance of the electrodes.

Continuing to block 1540 “identify a touch event based on the change in capacitance” the controller 126 may identify a touch event based on a change in the measured capacitance of the touch layer electrodes.

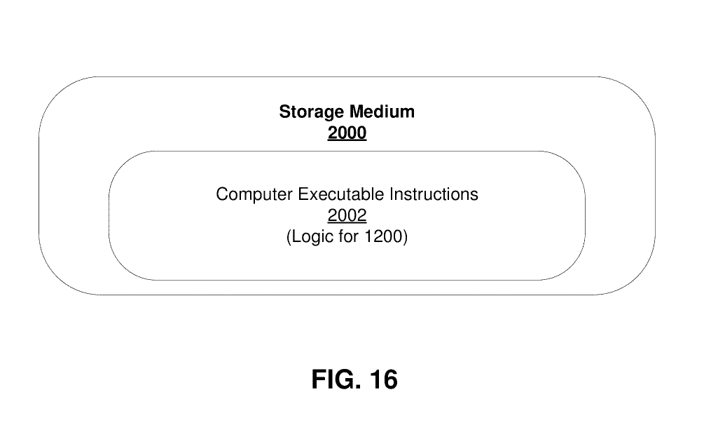

FIG. 16 illustrates an embodiment of a storage medium 2000. The storage medium 2000 may comprise an article of manufacture. In some examples, the storage medium 2000 may include any non-transitory computer readable medium or machine readable medium, such as an optical, magnetic or semiconductor storage. The storage medium 2000 may store various types of computer executable instructions e.g., 2002). For example, the storage medium 2000 may store various types of computer executable instructions to implement technique 1500.

Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

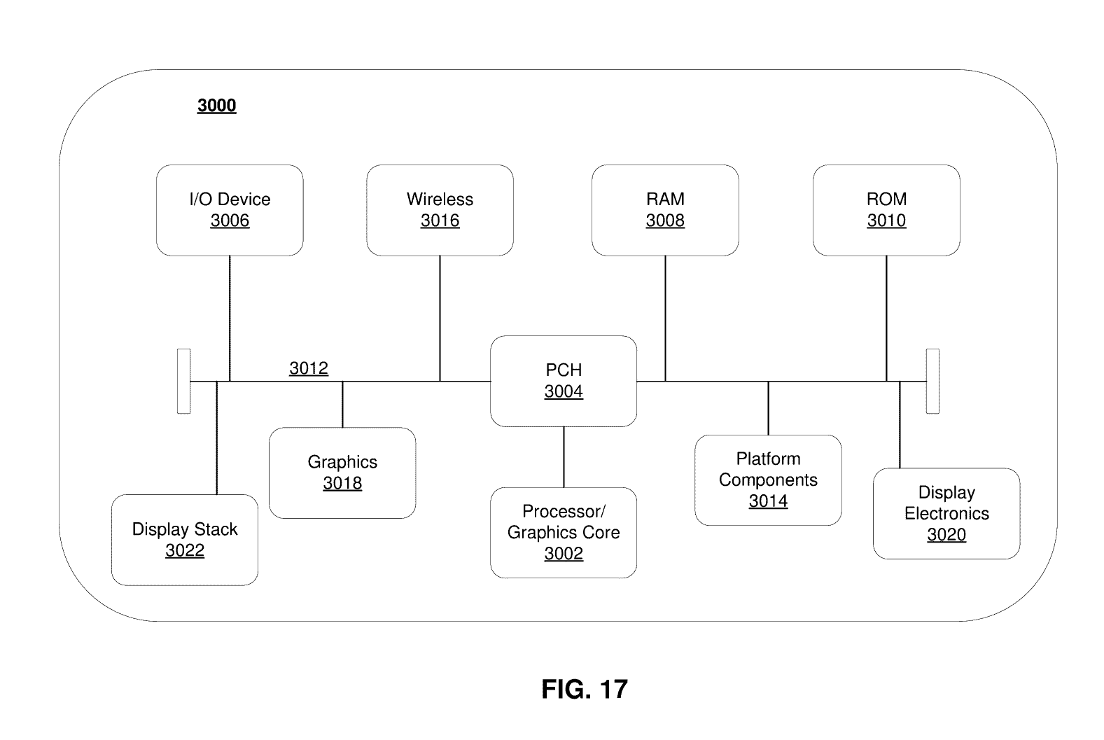

FIG. 17 is a diagram of an exemplary system embodiment and in particular, depicts a platform 3000, which may include various elements. For instance, this figure depicts that platform (system) 3000 may include a processor/graphics core 3002, a chipset/platform control hub (PCH) 3004, an input/output (I/O) device 3006, a random access memory (RAM) (such as dynamic RAM (DRAM)) 3008, and a read only memory (ROM) 3010, display electronics 3020, display 3022 (e.g., including an TSEPL, the TSEPL 122, or the like), and various other platform components 3014 (e.g., a fan, a cross flow blower, a heat sink, DTM system, cooling system, housing, vents, and so forth). System 3000 may also include wireless communications chip 3016 and graphics device 3018. The embodiments, however, are not limited to these elements.

As depicted, I/O device 3006, RAM 3008, and ROM 3010 are coupled to processor 3002 by way of chipset 3004. Chipset 3004 may be coupled to processor 3002 by a bus 3012. Accordingly, bus 3012 may include multiple lines.

Processor 3002 may be a central processing unit comprising one or more processor cores and may include any number of processors having any number of processor cores. The processor 3002 may include any type of processing unit, such as, for example, CPU, multi-processing unit, a reduced instruction set computer (RISC), a processor that have a pipeline, a complex instruction set computer (CISC), digital signal processor (DSP), and so forth. In some embodiments, processor 3002 may be multiple separate processors located on separate integrated circuit chips. In some embodiments processor 3002 may be a processor having integrated graphics, while in other embodiments processor 3002 may be a graphics core or cores.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

### Example 1

An apparatus, comprising: an touch sensitive electroactive privacy layer (TSEPL) for a display device, the TSEPL comprising: a plurality of top electrodes; a plurality of bottom electrodes; and a dielectric material disposed between the plurality of top electrodes and the plurality of bottom electrodes, the plurality of top electrodes and the plurality of bottom electrodes to activate portions of the dielectric material to form a plurality of micro louvers, the plurality of micro louvers to restrict a propagation direction of light emission associated with the display device; and a plurality of touch layer electrodes, the plurality of touch layer electrodes coupled to the plurality of top electrodes to change in capacitance to detect a touch.

### Example 2

The apparatus of example 1, the plurality of touch layer electrodes disposed substantially parallel to each other in a first direction, the plurality of top electrodes disposed substantially parallel to each other in a second direction and the plurality of bottom electrodes disposed substantially parallel to each other in a third direction.

### Example 3

The apparatus of example 2, the first direction substantially perpendicular to the second direction and substantially parallel to the third direction.

### Example 4

The apparatus of any one of examples 1 to 3, the TSEPL comprising: a transparent top plate having a first and a second surface, the plurality of top electrodes disposed on the second surface; and a transparent bottom plate having a third and a fourth surface, the plurality of bottom electrodes disposed on the third surface, the dielectric material disposed between the transparent top plate and the transparent bottom plate proximate to the second surface and the third surface.

### Example 5

The apparatus of any example 4, the TSEPL comprising a transparent substrate having a fifth and a sixth surface, the plurality of touch layer electrodes disposed on the fifth surface.

### Example 6

The apparatus of example 5, the transparent substrate disposed on the transparent top plate, the first surface proximate to the sixth surface.

### Example 7

The apparatus of example 6, comprising a transparent adhesive disposed between the first surface and the sixth surface.

### Example 8

The apparatus of example 7, comprising a transparent cover disposed on the plurality of touch layer electrodes.

### Example 9

The apparatus of example 4, the TSEPL comprising a transparent cover having a fifth and a sixth surface, the plurality of touch layer electrodes disposed on the sixth surface.

### Example 10

The apparatus of example 9, the transparent cover disposed on the transparent top plate, the plurality of touch layer electrodes proximate to the first surface.

### Example 11

The apparatus of example 10, comprising a transparent adhesive disposed between the first surface and the plurality of touch layer electrodes.

### Example 12

The apparatus of example 4, the plurality of touch layer electrodes disposed on the first surface.

### Example 13

The apparatus of example 12, comprising a transparent cover disposed on the transparent top plate proximate to the plurality of touch layer electrodes and the first surface.

### Example 14

The apparatus of example 13, comprising a transparent adhesive disposed between the first surface and the plurality of touch layer electrodes.

### Example 15

The apparatus of example 1, comprising: a power supply operably coupled to the plurality of top and the plurality of bottom electrodes; and a controller, the controller to send a control signal to the power supply to cause the power supply to create a voltage differential between the plurality of top electrodes and the plurality of bottom electrodes, the voltage differential to activate the portions of the dielectric material to form the plurality of micro louvers.

### Example 16

The apparatus of example 1, comprising: a power supply operably coupled to the plurality of touch layer electrodes; and a controller, the controller to send a control signal to the power supply to cause the power supply to apply a series of voltage pulses to the plurality of touch layer electrodes and to determine whether a capacitance of one or more of the plurality of touch layer electrodes changes based on the series of voltage pulses to detect a touch event.

### Example 17

The apparatus of example 1, comprising the display stack.

### Example 18

The apparatus of example 17, the display stack comprising one or more of a pressure layer, a protective layer, a liquid crystal display layer, a backlight layer, a light guide panel layer, and a display carrier layer.

### Example 19

A system, comprising: a display stack for a display device, the display stack comprising: a touch sensitive electroactive privacy layer (TSEPL) comprising: a plurality of top electrodes; a plurality of bottom electrodes; a dielectric material disposed between the plurality of top electrodes and the plurality of bottom electrodes, the plurality of top electrodes and the plurality of bottom electrodes to activate portions of the dielectric material to form a plurality of micro louvers, the plurality of micro louvers to restrict a propagation direction of light emission from the display stack; and a plurality of touch layer electrodes coupled to the plurality of top electrodes, a capacitance between the plurality of to detect a touch.

### Example 20

The system of example 19, the plurality of touch layer electrodes disposed substantially parallel to each other in a first direction, the plurality of top electrodes disposed substantially parallel to each other in a second direction and the plurality of bottom electrodes disposed substantially parallel to each other in a third direction.

### Example 21

The system of example 20, the first direction substantially perpendicular to the second direction and substantially parallel to the third direction.

### Example 22

The system of any one of examples 19 to 21, the TSEPL comprising: a transparent top plate having a first and a second surface, the plurality of top electrodes disposed on the second surface; and a transparent bottom plate having a third and a fourth surface, the plurality of bottom electrodes disposed on the third surface, the dielectric material disposed between the transparent top plate and the transparent bottom plate proximate to the second surface and the third surface.

### Example 23

The system of any example 22, the TSEPL comprising a transparent substrate having a fifth and a sixth surface, the plurality of touch layer electrodes disposed on the fifth surface.

### Example 24

The system of example 23, the transparent substrate disposed on the transparent top plate, the first surface proximate to the sixth surface.

### Example 25

The system of example 24, the TSEPL comprising a transparent adhesive disposed between the first surface and the sixth surface.

### Example 26

The system of example 25, the TSEPL comprising a transparent cover disposed on the plurality of touch layer electrodes.

### Example 27

The system of example 22, the TSEPL comprising a transparent cover having a fifth and a sixth surface, the plurality of touch layer electrodes disposed on the sixth surface.

### Example 28

The system of example 27, the transparent cover disposed on the transparent top plate, the plurality of touch layer electrodes proximate to the first surface.

### Example 29

The system of example 28, the TSEPL comprising a transparent adhesive disposed between the first surface and the plurality of touch layer electrodes.

### Example 30

The system of example 22, the plurality of touch layer electrodes disposed on the first surface.

### Example 31

The system of example 30, the TSEPL comprising a transparent cover disposed on the transparent top plate proximate to the plurality of touch layer electrodes and the first surface.

### Example 32

The system of example 31, comprising a transparent adhesive disposed between the first surface and the plurality of touch layer electrodes.

### Example 33

The system of example 19, comprising: a first power supply operably coupled to the plurality of top and the plurality of bottom electrodes; and a first controller, the controller to send a control signal to the first power supply to cause the first power supply to create a voltage differential between the plurality of top electrodes and the plurality of bottom electrodes, the voltage differential to activate the portions of the dielectric material to form the plurality of micro louvers.

### Example 34

The apparatus of example 33, comprising: a second power supply operably coupled to the plurality of touch layer electrodes, and a second controller, the second controller to send a control signal to the second power supply to cause the second power supply to apply a series of voltage pulses to the plurality of touch layer electrodes and to determine whether a capacitance of one or more of the plurality of touch layer electrodes changes based on the series of voltage pulses to detect a touch event.

### Example 35

The system of example 34, the first power supply and the second power supply the same power supply.

### Example 36

The system of example 34, the first and the second controller the same controller.

### Example 37

The system of example 19, the display stack comprising one or more of a pressure layer, a protective layer, a liquid crystal display layer, a backlight layer, a light guide panel layer, and a display carrier layer.

### Example 38

At least one non-transitory computer-readable storage medium comprising instructions that, when executed by a processor, cause the processor to: send a first control signal to a first voltage source to cause the first voltage source to apply a voltage to a first plurality of electrodes to create a potential difference between the first plurality of electrodes and a second plurality of electrodes, the first plurality of electrodes and the second plurality of electrodes disposed in an touch sensitive electroactive privacy layer (TSEPL) of a display device, the potential difference to form a plurality of micro louvers in a dielectric material disposed between the first plurality of electrodes and the second plurality of electrodes, the plurality of micro louvers to restrict a propagation direction of light emission associated with the display device; and send a second control signal to a second voltage source to cause the second voltage source to apply a series of voltage pulses to a plurality of touch layer electrodes, the plurality of touch layer electrodes coupled to the first plurality of electrodes to form a capacitance there between.

### Example 39

The at least one non-transitory computer-readable storage medium of example 38, comprising instructions that, when executed by the processor, cause the processor to: determine whether a capacitance between a one of the touch layer electrodes and a corresponding one of the first plurality of electrodes has changed; and detect a touch event based on a determination that the capacitance between the one of the touch layer electrodes and the corresponding one of the first plurality of electrodes has changed.

### Example 40

The at least one non-transitory computer-readable storage medium of example 38, the plurality of touch layer electrodes disposed substantially parallel to each other in a first direction, the plurality of top electrodes disposed substantially parallel to each other in a second direction and the plurality of bottom electrodes disposed substantially parallel to each other in a third direction.

### Example 41

The at least one non-transitory computer-readable storage medium of example 40, the first direction substantially perpendicular to the second direction and substantially parallel to the third direction.

### Example 42

The at least one non-transitory computer-readable storage medium of example 41, the TSEPL comprising: a transparent top plate having a first and a second surface, the plurality of top electrodes disposed on the second surface; and a transparent bottom plate having a third and a fourth surface, the plurality of bottom electrodes disposed on the third surface, the dielectric material disposed between the transparent top plate and the transparent bottom plate proximate to the second surface and the third surface.

### Example 43

The at least one non-transitory computer-readable storage medium of example 42, the TSEPL comprising a transparent substrate having a fifth and a sixth surface, the plurality of touch layer electrodes disposed on the fifth surface.

### Example 44

The at least one non-transitory computer-readable storage medium of example 43, the transparent substrate disposed on the transparent top plate, the first surface proximate to the sixth surface.

### Example 45

The at least one non-transitory computer-readable storage medium of example 44, comprising a transparent adhesive disposed between the first surface and the sixth surface.

### Example 46

The at least one non-transitory computer-readable storage medium of example 45, comprising a transparent cover disposed on the plurality of touch layer electrodes.

### Example 47

The at least one non-transitory computer-readable storage medium of example 42, the TSEPL comprising a transparent cover having a fifth and a sixth surface, the plurality of touch layer electrodes disposed on the sixth surface.

### Example 48

The at least one non-transitory computer-readable storage medium of example 47, the transparent cover disposed on the transparent top plate, the plurality of touch layer electrodes proximate to the first surface.

### Example 49

The at least one non-transitory computer-readable storage medium of example 48, comprising a transparent adhesive disposed between the first surface and the plurality of touch layer electrodes.

### Example 50

The at least one non-transitory computer-readable storage medium of example 42, the plurality of touch layer electrodes disposed on the first surface.

### Example 51

The at least one non-transitory computer-readable storage medium of example 50, comprising a transparent cover disposed on the transparent top plate proximate to the plurality of touch layer electrodes and the first surface.

### Example 52

The at least one non-transitory computer-readable storage medium of example 51, comprising a transparent adhesive disposed between the first surface and the plurality of touch layer electrodes.

### Example 53

A method comprising: sending a first control signal to a first voltage source to cause the first voltage source to apply a voltage to a first plurality of electrodes to create a potential difference between the first plurality of electrodes and a second plurality of electrodes, the first plurality of electrodes and the second plurality of electrodes disposed in an touch sensitive electroactive privacy layer (TSEPL) of a display device, the potential difference to form a plurality of micro louvers in a dielectric material disposed between the first plurality of electrodes and the second plurality of electrodes, the plurality of micro louvers to restrict a propagation direction of light emission associated with the display device; and sending a second control signal to a second voltage source to cause the second voltage source to apply a series of voltage pulses to a plurality of touch layer electrodes, the plurality of touch layer electrodes coupled to the first plurality of electrodes to form a capacitance there between.

### Example 54

The at least one non-transitory computer-readable storage medium of example 38, comprising instructions that, when executed by the processor, cause the processor to: determining whether a capacitance between a one of the touch layer electrodes and a corresponding one of the first plurality of electrodes has changed; and detecting a touch event based on a determination that the capacitance between the one of the touch layer electrodes and the corresponding one of the first plurality of electrodes has changed.

### Example 55

The at least one non-transitory computer-readable storage medium of example 53, the plurality of touch layer electrodes disposed substantially parallel to each other in a first direction, the plurality of top electrodes disposed substantially parallel to each other in a second direction and the plurality of bottom electrodes disposed substantially parallel to each other in a third direction.

### Example 56

The at least one non-transitory computer-readable storage medium of example 55, the first direction substantially perpendicular to the second direction and substantially parallel to the third direction.

### Example 57

The at least one non-transitory computer-readable storage medium of example 56, the TSEPL comprising: a transparent top plate having a first and a second surface, the plurality of top electrodes disposed on the second surface; and a transparent bottom plate having a third and a fourth surface, the plurality of bottom electrodes disposed on the third surface, the dielectric material disposed between the transparent top plate and the transparent bottom plate proximate to the second surface and the third surface.

### Example 58

The at least one non-transitory computer-readable storage medium of example 57, the TSEPL comprising a transparent substrate having a fifth and a sixth surface, the plurality of touch layer electrodes disposed on the fifth surface.

### Example 59

The at least one non-transitory computer-readable storage medium of example 58, the transparent substrate disposed on the transparent top plate, the first surface proximate to the sixth surface.

### Example 60

The at least one non-transitory computer-readable storage medium of example 57, comprising a transparent adhesive disposed between the first surface and the sixth surface.

### Example 61

The at least one non-transitory computer-readable storage medium of example 60, comprising a transparent cover disposed on the plurality of touch layer electrodes.

### Example 62

The at least one non-transitory computer-readable storage medium of example 57, the TSEPL comprising a transparent cover having a fifth and a sixth surface, the plurality of touch layer electrodes disposed on the sixth surface.

### Example 63

The at least one non-transitory computer-readable storage medium of example 62, the transparent cover disposed on the transparent top plate, the plurality of touch layer electrodes proximate to the first surface.

### Example 64

The at least one non-transitory computer-readable storage medium of example 48, comprising a transparent adhesive disposed between the first surface and the plurality of touch layer electrodes.

### Example 65

The at least one non-transitory computer-readable storage medium of example 57, the plurality of touch layer electrodes disposed on the first surface.

### Example 66

The at least one non-transitory computer-readable storage medium of example 65, comprising a transparent cover disposed on the transparent top plate proximate to the plurality of touch layer electrodes and the first surface.

### Example 67

The at least one non-transitory computer-readable storage medium of example 66, comprising a transparent adhesive disposed between the first surface and the plurality of touch layer electrodes.

### Example 68

An apparatus comprising means to perform the method of any one of examples 53 to 67.

What is claimed is:

1. An apparatus, comprising:
an touch sensitive electroactive privacy layer (TSEPL) for a display device, the TSEPL comprising:
a plurality of top electrodes;
a plurality of bottom electrodes; and
a dielectric material disposed between the plurality of top electrodes and the plurality of bottom electrodes, the plurality of top electrodes and the plurality of bottom electrodes to activate portions of the dielectric material to form a plurality of micro louvers, the plurality of micro louvers to restrict a propagation direction of light emission associated with the display device; and
a plurality of touch layer electrodes, the plurality of touch layer electrodes coupled to the plurality of top electrodes to change in capacitance to detect a touch.

2. The apparatus of claim 1, the plurality of touch layer electrodes disposed substantially parallel to each other in a first direction, the plurality of top electrodes disposed substantially parallel to each other in a second direction and the plurality of bottom electrodes disposed substantially parallel to each other in a third direction.

3. The apparatus of claim 2, the first direction substantially perpendicular to the second direction and substantially parallel to the third direction.

4. The apparatus of claim 1, the TSEPL comprising:
a transparent top plate having a first and a second surface, the plurality of top electrodes disposed on the second surface; and
a transparent bottom plate having a third and a fourth surface, the plurality of bottom electrodes disposed on the third surface, the dielectric material disposed between the transparent top plate and the transparent bottom plate proximate to the second surface and the third surface.

5. The apparatus of any claim 4, the TSEPL comprising a transparent substrate having a fifth and a sixth surface, the plurality of touch layer electrodes disposed on the fifth surface.

6. The apparatus of claim 5, the transparent substrate disposed on the transparent top plate, the first surface proximate to the sixth surface.

7. The apparatus of claim 6, comprising a transparent adhesive disposed between the first surface and the sixth surface.

8. The apparatus of claim 7, comprising a transparent cover disposed on the plurality of touch layer electrodes.

9. The apparatus of claim 4, the TSEPL comprising a transparent cover having a fifth and a sixth surface, the plurality of touch layer electrodes disposed on the sixth surface.

10. The apparatus of claim 9, the transparent cover disposed on the transparent top plate, the plurality of touch layer electrodes proximate to the first surface.

11. The apparatus of claim 10, comprising a transparent adhesive disposed between the first surface and the plurality of touch layer electrodes.

12. The apparatus of claim 4, the plurality of touch layer electrodes disposed on the first surface.

13. The apparatus of claim 12, comprising a transparent cover disposed on the transparent top plate proximate to the plurality of touch layer electrodes and the first surface.

14. The apparatus of claim 13, comprising a transparent adhesive disposed between the first surface and the plurality of touch layer electrodes.

15. The apparatus of claim 1, comprising the display stack, the display stack comprising one or more of a pressure layer, a protective layer, a liquid crystal display layer, a backlight layer, a light guide panel layer, and a display carrier layer.

16. A system, comprising:
a display stack for a display device, the display stack comprising:
a touch sensitive electroactive privacy layer (TSEPL) comprising:
a plurality of top electrodes;
a plurality of bottom electrodes;
a dielectric material disposed between the plurality of top electrodes and the plurality of bottom electrodes, the plurality of top electrodes and the plurality of bottom electrodes to activate portions of the dielectric material to form a plurality of micro louvers, the plurality of micro louvers to restrict a propagation direction of light emission from the display stack; and
a plurality of touch layer electrodes coupled to the plurality of top electrodes, a capacitance between the plurality of to detect a touch.

17. The system of claim 16, the plurality of touch layer electrodes disposed substantially parallel to each other in a first direction, the plurality of top electrodes disposed substantially parallel to each other in a second direction and the plurality of bottom electrodes disposed substantially parallel to each other in a third direction.

18. The system of claim 17, the first direction substantially perpendicular to the second direction and substantially parallel to the third direction.

19. The system of claim 16, the TSEPL comprising:
a transparent top plate having a first and a second surface, the plurality of top electrodes disposed on the second surface:
a transparent bottom plate having a third and a fourth surface, the plurality of bottom electrodes disposed on the third surface, the dielectric material disposed between the transparent top plate and the transparent bottom plate proximate to the second surface and the third surface; and
a transparent substrate having a fifth and a sixth surface, the plurality of touch layer electrodes disposed on the fifth surface, the transparent substrate disposed on the transparent top plate, the first surface proximate to the sixth surface.

20. The system of claim 16, the TSEPL comprising a transparent cover having a fifth and a sixth surface, the plurality of touch layer electrodes disposed on the sixth surface, the transparent cover disposed on the transparent top plate, the plurality of touch layer electrodes proximate to the first surface.

21. The system of claim 22, the plurality of touch layer electrodes disposed on the first surface.

22. The system of claim 19, comprising:
a first power supply operably coupled to the plurality of top and the plurality of bottom electrodes;
a first controller, the controller to send a control signal to the first power supply to cause the first power supply to create a voltage differential between the plurality of top electrodes and the plurality of bottom electrodes, the voltage differential to activate the portions of the dielectric material to form the plurality of micro louvers;
a second power supply operably coupled to the plurality of touch layer electrodes; and
a second controller, the second controller to send a control signal to the second power supply to cause the second power supply to apply a series of voltage pulses to the plurality of touch layer electrodes and to determine whether a capacitance of one or more of the plurality of touch layer electrodes changes based on the series of voltage pulses to detect a touch event.

23. The system of claim 22, the first power supply and the second power supply the same power supply and the first and the second controller the same controller.

24. At least one non-transitory computer-readable storage medium comprising instructions that, when executed by a processor, cause the processor to:
send a first control signal to a first voltage source to cause the first voltage source to apply a voltage to a first plurality of electrodes to create a potential difference between the first plurality of electrodes and a second plurality of electrodes, the first plurality of electrodes and the second plurality of electrodes disposed in an touch sensitive electroactive privacy layer (TSEPL) of a display device, the potential difference to form a plurality of micro louvers in a dielectric material disposed between the first plurality of electrodes and the second plurality of electrodes, the plurality of micro louvers to restrict a propagation direction of light emission associated with the display device; and
send a second control signal to a second voltage source to cause the second voltage source to apply a series of voltage pulses to a plurality of touch layer electrodes, the plurality of touch layer electrodes coupled to the first plurality of electrodes to form a capacitance there between.

25. The at least one non-transitory computer-readable storage medium of claim 24, comprising instructions that, when executed by the processor, cause the processor to:
determine whether a capacitance between a one of the touch layer electrodes and a corresponding one of the first plurality of electrodes has changed; and
detect a touch event based on a determination that the capacitance between the one of the touch layer electrodes and the corresponding one of the first plurality of electrodes has changed.

26. The at least one non-transitory computer-readable storage medium of claim 25, the plurality of touch layer electrodes disposed substantially parallel to each other in a first direction, the plurality of top electrodes disposed substantially parallel to each other in a second direction and the plurality of bottom electrodes disposed substantially parallel to each other in a third direction, the first direction substantially perpendicular to the second direction and substantially parallel to the third direction.
